(19) United States
(12) Patent Application Publication
(10) Pub. No.: US 2008/0250227 A1
(43) Pub. Date: Oct. 9, 2008

(54) General Purpose Multiprocessor Programming Apparatus And Method

(76) Inventors: Michael D. Linderman, Palo Alto, CA (US); Teresa H. Meng, Saratoga, CA (US)

Correspondence Address: PILLSBURY WINTHROP SHAW PITTMAN LLP, P.O. BOX 10500, MCLEAN, VA, 22102, US

(21) Appl. No.: 11/696,717

(22) Filed: Apr. 4, 2007

(51) Int. Cl. G06F 15/00

(52) U.S. Cl. 712/32; 712/E09.001

(57) ABSTRACT

The present invention provides methods and apparatus for highly efficient parallel operations using a reduction unit. In a particular aspect, there is provided an apparatus and method for parallel computing. In each of the apparatus and method, there are performed independent operations by a plurality of processing units to obtain a sequence of results from each of the processing units, the step of performing independent operations including accessing data from a common memory by each of the plurality of processing units. There are also operations performed upon each of the results obtained from each of the processing units using a reduction unit to obtain a globally coherent and strictly consistent state signal, the globally coherent and strictly consistent state signal being fed back to each of the plurality of processing units in order to synchronize operations therebetween.

### BACKGROUND OF THE INVENTION

In 2002 there was an estimated 4.6 exabytes of new stored and 18 exabytes of new transmitted digital information, with both numbers growing at 30% a year. The growing digital data corpus drives increasingly demanding informatics applications (i.e. programs which mine, analyze or synthesize digital data). These applications are very different, however, from the physical simulation, audio/video decode, and database workloads that currently drive high performance computing (HPC) system design. Informatics workloads are characterized by a nearly unbounded workload size, extreme bandwidth asymmetry, high compute densities, and complex datasets. The user groups are different as well. Exponential information growth is occurring in a wide range of domains, including medicine, biology, entertainment, finance and security. These users are typically domain experts, solving difficult problems, not parallel programming gurus, and do not, and cannot be expected to, have the level of expertise currently required to use existing HPC systems.

One challenge that the present invention addresses is the development of a programming model that enable a diverse, non-expert user base to easily develop parallel applications, and the many-core programming architecture to execute those programs quickly and efficiently.

As mentioned above, unlike applications in which the workload size is fixed, and performance improvements are translated into reduced execution time, informatics applications are effectively unbounded. All performance improvements are converted into solving harder problems with larger datasets. Thus the amount of available parallelism is both large and growing. Further there are relatively few legacy concerns. These applications largely do not exist yet, or if they do, only in very high level prototyping languages (like MATLAB or R). The structure of informatics programs make them well suited to many-core parallel computing platforms, while the minimal legacy concerns give designers the freedom to explore new programming models and computational hardware architectures. To support a range of new architectures, and stave off legacy constraints, efficient, portable encodings, at both the program and ISA (Instruction Set Architecture) level, of the parallel dependency graph are required. These encodings should ensure a minimum of unnecessary sequential constraints, while providing that maximum amount of information about the structure of the computation, including parallelism at multiple granularities, the structure of memory of accesses and thread interactions.

MapReduce is a known programming tool developed by Google, which is supported in C++, Python and Java, in which parallel computations over large (greater than 1 terabyte) data sets are performed. The name is derived from the map and reduce functions commonly used in functional programming (a map function takes a function and a set of data objects as input, and applies the function to all objected in the input set, a reduce function takes a combiner function and a set of data objects as input, and applies the combiner function to pairs drawn from the input set and intermediate results until only a single result is obtained). The actual software is implemented by specifying a Map function that maps key-value pairs to new key-value pairs, potentially in parallel, and a subsequent Reduce function that consolidates all mapped key-value pairs sharing the same keys to single key-value pairs. MapReduce greatly reduced the complexity and difficulty of developing parallel programs. The data mining tasks undertaken at Google are classic recognition and mining informatics applications. The MapReduce model has been ported to a number of other parallel platforms, in addition to Google's large cluster, showing that this approach is portable and scalable.

Google's MapReduce library targets very coarse granularities, on the order of files spread across large, multi-machine clusters. And as a result their implementation is less suitable for numerical data processing at finer granularities. The map and reduce concepts, however, are equally applicable, and useful, for numerical processing and other fine grain computations. Map tasks are conceptually similar to the vector-thread paradigm, in which blocks of one or more RISC-like instructions (sometimes termed atomic instruction blocks, AIBs) are applied to an input vector in parallel. A purely vector approach, however, ignores the structure in reduction operations. The present invention, as will be described hereinafter, uses the reduction tasks, explicitly identified in a program constructed from sets of map and reduce operations, to enable optimized, low-cost, thread interaction, via dedicated hardware reduction units, as well as other advantages, as will be described.

### SUMMARY OF THE INVENTION

The present invention provides methods and apparatus for highly efficient parallel operations using a reduction unit.

In a particular aspect, there is provided an apparatus and method for parallel computing. In each of the apparatus and method, there are performed independent operations by a plurality of processing units to obtain a sequence of results from each of the processing units, the step of performing independent operations including accessing data from a common memory by each of the plurality of processing units. There are also operations performed upon each of the results obtained from each of the processing units using a reduction unit to obtain a globally coherent and strictly consistent state signal, the globally coherent and strictly consistent state signal being fed back to each of the plurality of processing units in order to synchronize operations therebetween.

As a result, one of the advantages of the present invention is data accesses at a high bandwidth, wherein results obtained from the parallel processing units can be reduced and interacted upon at low latency in the reduction unit, thereby achieving efficient operations.

Another advantage of the present invention is that software can be written in a simple programming format that does not require the user to understand the complexities of parallel processing, yet the program can be operated upon by the parallel computing architecture described herein.

### BRIEF DESCRIPTION OF THE DRAWINGS

These and other aspects and features of the present invention will become apparent to those of ordinary skill in the art upon review of the following description of specific embodiments of the invention in conjunction with the accompanying figures, wherein:

FIG. 1 illustrates RMS application classes;

FIG. 2 illustrates an overview of the merge architecture according to the present invention;

FIG. 3 illustrates a block diagram of a processor element according to the present invention;

FIG. 4 illustrates a block diagram of a reduction unit according to the present invention;

FIG. 5 illustrates a block diagrams of an exemplary arithmetic tree node unit within a reduction unit of the present invention; and

FIGS. 6(a) and 6(b) illustrate graphs showing the efficiency of the present invention.

### DETAILED DESCRIPTION OF THE PREFERRED EMBODIMENTS

The exponential growth in digital information has and will continue to drive increasingly demanding information processing applications. Parallel computing systems and programming models that target physical simulation or multimedia processing are not well suited for informatics applications, which are characterized by extreme bandwidth asymmetry. The merge framework method of the present invention is a general purpose programming model and novel CMP architecture, which makes bandwidth asymmetry the defining computational primitive. The merge framework method hierarchically decomposes all computations into a set of parallel map operations and a reduction operation. This decomposition is directly reflected in the microarchitecture, with dedicated hardware mechanisms for encoding and executing reduction operations, as described hereinafter. The reductions units provide intuitive and highly efficient thread interaction mechanisms, improving performance and execution efficiency while reducing compilation difficulty.

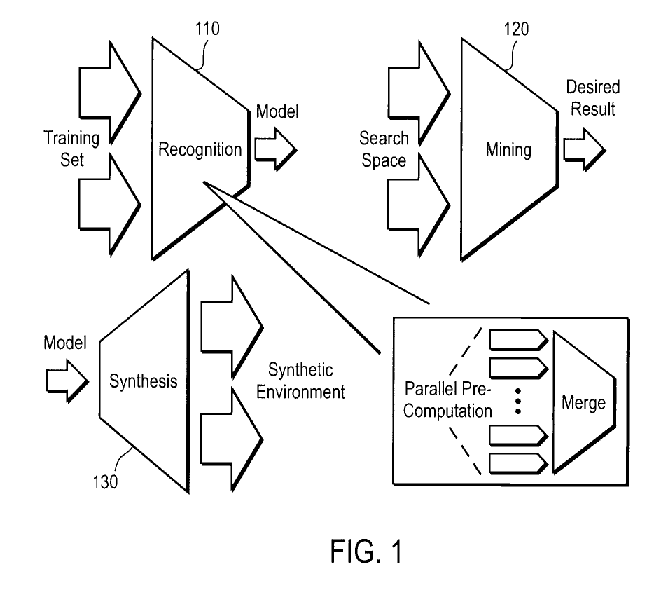

The input-bandwidth asymmetry on which the present invention is motivated, is fundamental to informatics applications, and illustrated in FIG. 1. Such informatics applications typically belong to one of three broad classes defined in the RMS taxonomy. The classes are:

1. Recognition “R” class 110: The ability to recognize patterns and models of interest to a specific application requirement that has a training set input 1 12 to obtain a model 1 14 that will allow for the recognition based on the training set input 1 14.

2. Mining “M” class 120: The ability to examine or scan large amounts of real-world data for patterns of interest in a search set 122 to obtain a desired result 124

3. Synthesis “S” class 130: The ability to synthesize large datasets or a virtual world based on the patterns or models of interest.

A recognition class 110 problem will necessarily have a large input bandwidth, comprising the whole of the training set. The output bandwidth however, assuming an effective model is produced, is very small; potentially many orders of magnitude smaller. The other two classes, mining class 120 and synthesis class 130, show similar input-output bandwidth asymmetry, indicating that extreme data reduction or generation is the core of all three classes.

All map tasks are defined, according to the present invention, as computations that can be applied independently, and thus potentially concurrently, to a set of data elements. The combination, reduction or interaction the results of the map computations are defined as the reduction tasks. Using inner product as a simple example, the multiplications are defined as map tasks and the sum as the reduction task. Although “map” terminology is typically used to describe applications of a single code block to multiple data elements (effectively Single Program Multiple Data, SPMD), in the context of this invention, a set of map tasks includes not only this, but are defined more broadly to also include different code blocks that might be executed concurrently (effectively Multiple Program Multiple Data, MPMD

The map and reduce decomposition is applied hierarchically across the whole range of granularities, from single operations, such as multiplies in an inner product, to complex algorithms. The resulting description of the program provides a compact encoding of the parallel dataflow graph. The application of a function to large number of inputs, therefore the division of potentially parallel computations, like the multiplies in an inner product, into a set of potential tasks, is expressed explicitly and simply as map of that function over the inputs. Similarly the tree based combination of multiple data elements to a single, or small number of results is expressed explicitly and simply as the reduction, using a combining function, over the inputs. The implicit tree-based dataflow captures the parallelism available within the tree itself, some thing that is difficult to express in traditional programming models and ISAs which do not have these concepts.

The more expansive definition of reduction operations used in this invention, which allows for arbitrary operations as opposed to models that only support traditional associative operators, allows the programmer to better distinguish, and encode, the structure of task interactions. Any synchronization that might be needed to ensure a correct result of a particular algorithm is expressed implicitly in the algorithm, as opposed to through the addition of implementation specific external primitives, providing a deterministic abstract execution model to the user. Using inner product again as the example, if the multiplies and updates to the output sum are occurring in parallel, depending on the architecture, different mechanisms are needed to prevent race conditions on sum. By expressing the sum as a reduction, the requirement to prevent races during updates is implicit in the description, and will be automatically handled during the compilation process, either by inserting the necessary synchronization primitives, such as locks, or by allocating the computation to hardware resources which do require external synchronization.

Reduction operations are often the limiting factor for program performance. Distinguishing reduction operations from the map tasks, as mentioned previously, allows for dedicated hardware units, optimized for low-cost thread interaction. Reduced thread interaction cost in turn enables efficient execution of applications with both coarse grain task and fine grain data parallelism, which provides many advantages as discussed herein.

The semantics of a set of map operations, in which a function, or code block, is applied to set of data inputs provides the opportunity to construct large structured data accesses. When multiple invocations of a map task are combined to form an execution thread, all of the data elements those tasks are “mapped on” can be similarly be bundled together and fetched as one large block from memory (which will be much more efficient). Assembling structured accesses is difficult if the data load and store instructions are part of the mapped instruction block. As such, another significant feature of the present invention is to provide a specific iterator or reader interface for memory accesses (in both the program and ISA) so that memory accesses can be explicitly identified, and assembled or structured to best suit the underlying implementation. Such an approach provides all the benefits of vector access, but at larger granularities, without the need to manually assemble and schedule bulk data accesses. And as with the reduction operations, distinguishing these computations enables the compiler to make better use of dedicated hardware resources.

An architecture is characterized by both the abstract model presented to the programmer and the implementation of that model. This section describes the abstract model of the merge framework method of the present invention, and provides an overview of a physical implementation of the merge framework architecture.

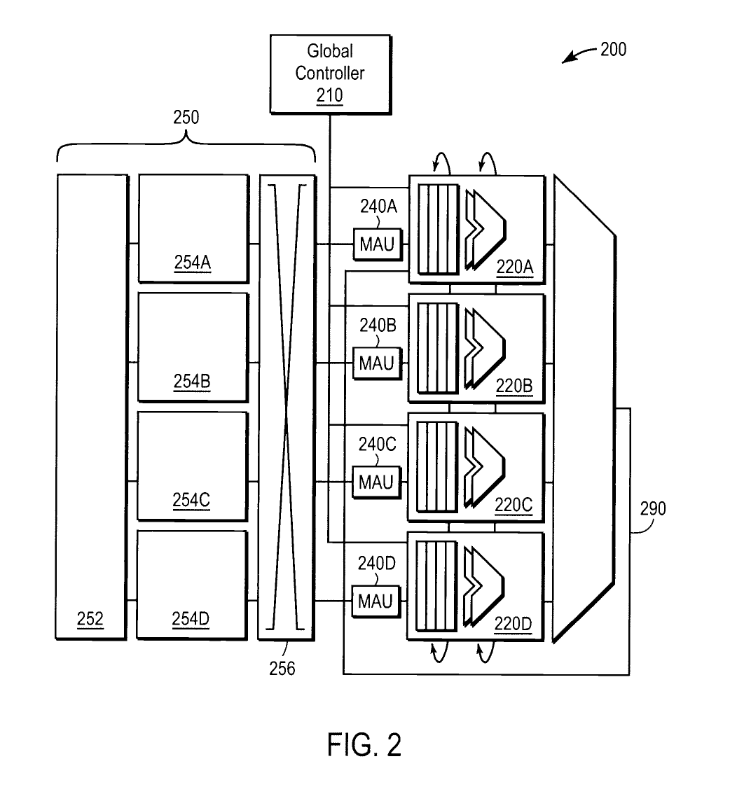

As illustrated in FIG. 2, the merge architecture 200 includes a conventional scalar global control processor 210 that manages a set of independent processing elements (PEs 220 A-D), which as shown in a preferred embodiment are arranged in a row. Memory access units (MAUs 240A-D, that each have associated cache memory, and the construction of which are known) (one for each PE 220) allow for access to a shared memory space, and a multi-bank, multi-port cache. Memory system 250 includes a main memory interface controller 252 that communicates with off-chip DRAM (not shown), cache memory units 254A-D, and a network switch 256 that connects each of the cache units 254 to the different MAU's 240. A reduction unit 260, also referred to as an interaction unit as it can both reduce and/or interact data and tokens from different PE's 220 as will be described hereinafter, is connected to the set of independent processing units 220A-D.

It is understood that the control processor 210 can control more PEs 220 that each are associated with the same reduction unit 260, or the control processor 210 can also control PEs 220 that each are associated with another reduction unit 260. Applications can be mapped to merge architecture in a number of ways, but in general all map operations are executed on the PEs 220, with the control processor 210 managing the execution.

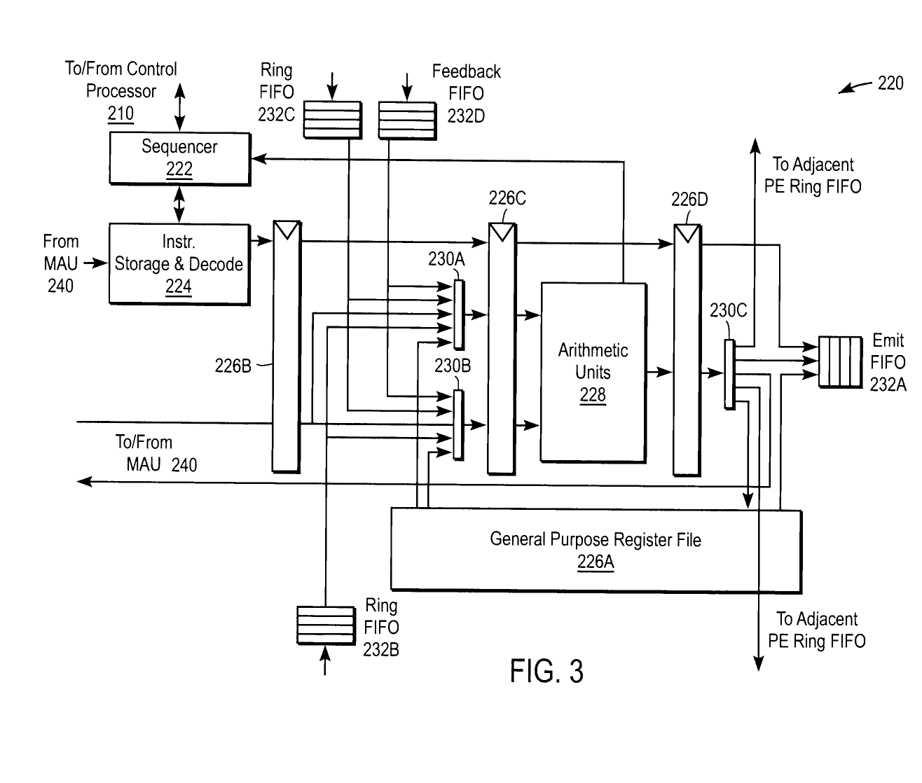

A processing element 220 is illustrated in more detail in FIG. 3, and contains a program counter/sequencer 222 (and associated interface to controller 210), an instruction fetch mechanism 224that includes a local instruction store, a set of registers 226 (including a general register file 226A and pipeline registers, which, for example, can be a pipeline register 226 B separating the instruction storage and decode from the operand fetch, a pipeline register 226 C separating the operand fetch from the execution stage, and a pipeline register 226D that separates the execution stage from writeback), arithmetic units 228, multiplexers 230 A, B, and C which are a controlled by the instruction moving through the pipeline, and control which operands are used, and are based on the fields in the decoded instruction, and various interface mailbox FIFO's 232, including emit interface FIFO 232A that communicates with the reduction unit 260 and adjacent PE interface ring FIFOs 232B and 232C that allows adjacent PE's 220 to communicate with each other, and feedback interface FIFO 232D.

Each processing element 220 executes a RISC-like instruction set, although it is not limited to such. PE instructions are grouped into discrete instruction blocks (IBs). The program counter/sequencer 222 and instruction fetch mechanism 224 within the PE 220 is in the context of the IB; a jump to a different instruction block is an explicit global instruction block fetch (initiated by the PE 220 itself or the control processor). IBs are not limited to straight-line code, or a single exit. Both local control flow within the IB and multiple global exits are supported.

The control processor 21 0 directs the PEs 220 execution, as well the memory fetch to memory 250 and the reduction unit 260, through a series of control messages and translation tables. Issuing identical global instruction messages to the PEs 220 (or maintaining identical translation entries) provides an SPMD (Single Program Multiple Data) execution model similar to vector-thread approaches. Each processing element 220 may execute the same instruction block, however, there is no imposed synchronization between PE units 220. PEs 220 may slip relative to each other in response to local or global control flow, memory latencies, etc. When different instruction blocks are issued to different ones of the PEs 220, the PEs 220 then function as a true MPMD (Multiple Program Multiple Data) architecture.

To support mappability beyond the fine grain data parallelism exploited in vector machines, memory accesses are identified by virtual stream identifiers, which index into translation tables in the memory access units 240, as is known. Neither the PEs 220 nor the control processor 21 0, in a preferred embodiment, perform direct memory accesses, and PEs 220 do not reference actual addresses. Instead, in the preferred embodiment, the control processor 21 0 provides to the MAUs 240 a memory access instruction block which specifies the actual address in the memory 250, and access pattern for given stream on a given PE 220. When a PE 220 requests a stream, the corresponding MAU 240 obtains the necessary memory access instruction block if it does not already have it, and independently begins issuing requests to the memory 250 (effectively a DMA memory access). All requests are returned to an internal memory store in the MAU 240, accessible to the PE 220 via a blocking FIFO mailbox interface disposed within the MAU 240. Internal storage in the MAU 240 is treated as an ordered buffer for each virtual stream, with tracking logic for data movement direction (stores: PE 220 to memory 250, loads: Memory 250 to PE 220) and full/empty status. The ordering logic ensures FIFO access semantics for each stream. When data is written to the MAU internal storage buffer, the affected entries are marked full, and when data is read from the internal storage buffer, the affected entries are marked empty. Entries marked full cannot be overwritten, and entries marked empty cannot be read. Architectural entities (the PE 220 or memory system 250) will block (activity upon blocking is dependent on the unit) if write to a full entry, or a read from an empty entry is attempted. No additional constraints are placed upon the MAU buffer, both the PE 220 and memory system 250 can access different entries in the internal storage buffer of the MAU 240 simultaneously.

Other FIFO interface units, each with their own internal buffer storage, are used between the PEs 220 and the reduction unit 260, and between the PEs 220 themselves when implemented as a bidirectional ring network. These interface FIFO units are emit interface FIFO 232A, adjacent PE interface ring FIFOs 232B and 232C, and feedback interface FIFO 232D, mentioned previously, which, in the preferred embodiment, are treated like registers in the ISA, and can be used as source or destination operands for instructions, as appropriate, without explicit moves to and from the general register file. Data transfers to the reduction unit 260 are a special case. Termed emits, these transfers include a key (fetched from the register file) and an emit operation type (ADD, MAX, etc.) along with the operands. One format of an emit is shown below:

| | | | |
|---|---|---|---|
| Origin PE | Operation | Operand | Key |

Other formats are also usable.

The FIFO interfaces (232A-D) and the MAU's 240A-D enable dynamic communication scheduling and distributed synchronization.

The other interface FIFOs are part of the architectural state, and, as such, rollback (undoing operations), is preferably not implemented using the present invention, so the PEs 220 must be in-order, such that instructions are issued in the order they are written, as is known. To mitigate pipeline stalls created by control flow, the structured stream accesses can be used to control execution. Branch instructions base on stream completion information from the MAU 240 can be evaluated by the instruction fetch logic early in the pipeline reducing control-flow related stalls. Stream-based branching also improves mappability by reducing the need to pass execution parameters to the PEs 220 via memory accesses or from the control processor. Instead, loop bounds are passed implicitly by the control processor 210 in the memory access instruction blocks, simplifying “calling” a function, and enabling sophisticated runtime remapping of a computation through changes to the stream allocations.

Simultaneous Multithreading (SMT) is also used to reduce the pipeline stalls created by control flow and instruction dependencies. Multiple (greater than 2) concurrently executed threads are supported per PE 220. Each thread context is provided separate architectural state, including instruction store, program counter, register file and feedback and bidirectional ring mailbox interface units, but shares the execution pipeline and emit interface. The MAU services all the threads, providing uniquely identified separate virtual stream entries and internal buffer entries. The ring network connections are dependent on the number of currently active threads. When more than one thread is active, the ring is constructed so that threads sharing the same PE 220 will appear logically adjacent, as though they were executing on adjacent PEs 220. Thus if two threads are executing, an “outwards” transmission will either be received by an physically separate, adjacent PE 220, (if the thread is the logically outer thread) or received by the other thread sharing the PE 220 (if the transmitting threads is logically the inner thread).

Thread context switches are managed by logic local to the PE 220. Blocked reads/writes to/from interface units and pipeline stalls resulting from control latency or instructions dependencies will trigger automatic context switches.

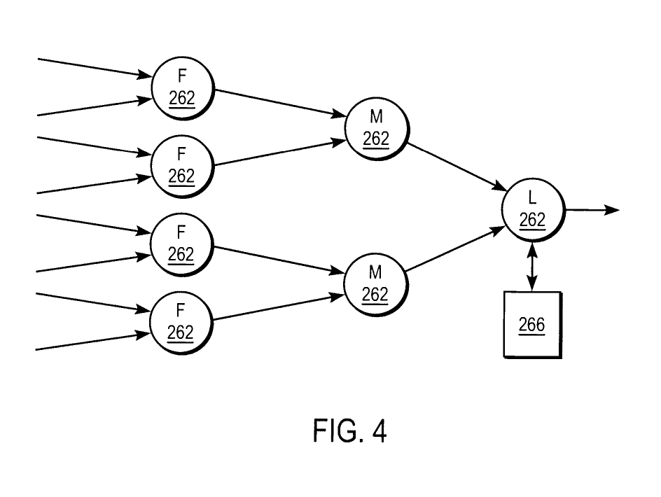

As mentioned, each PE 220 has an emit interface FIFO 232A that allows transmissions to the reduction unit 260, as referred to previously. The reduction unit 260, in an abstract sense, takes the form of a tree of operation units 262-F first level, 262-M middle levels, and 262-L last level (also referred to as tree nodes 262) (though the embodiment illustrated in FIG. 4 shows all of these levels, in an implementation with only 4 PE's 200 only 2 levels are required, a first level 262-F and a last level 262-L, with the last level operation unit 262-L forming the root of the tree that provides a globally coherent and strictly consistent data and signals to the other PE's 220 as will be described in detail further hereinafter. As an overview, however, it will be apparent that the output of the tree within the reduction unit 260 is both coherent, in that there are not multiple copies of any data that must be kept in sync, and strictly consistent, in that any read will see the results of the most recent previous write; both conditions are equally important.

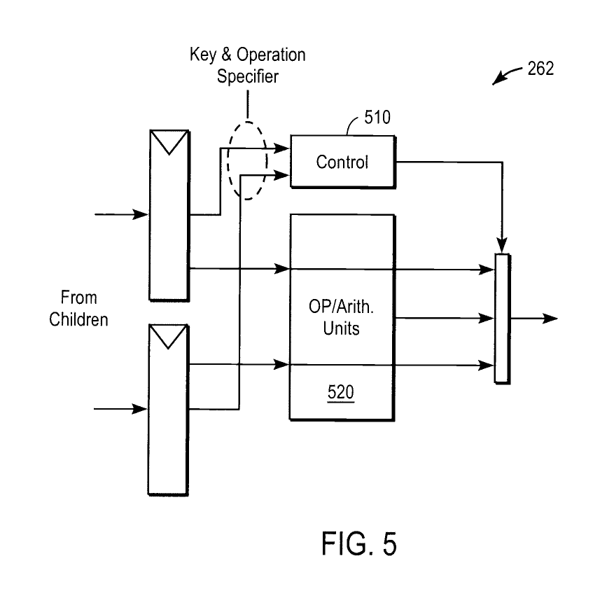

Each node (i.e. operation unit 262) in the tree implements a set of integer and/or floating point and/or other logic, associative, other arithmetic or other operations. FIG. 5 illustrates a block diagram of one tree node unit 262 within a reduction unit 260, and illustrates the key and operation specifier that are provided to the control unit 510, as well as the data that is provided to the operation/arithmetic units 520. In certain implementations certain of the nodes do not necessarily need to implement arithmetic operations. The operation units, when performing arithmetic operations, can have integer or floating point implementations. The pipeline registers which separate parent and child nodes are not shown.

When two operands arrive at a tree node 262 during the same cycle, they will be reduced if they have the same key and operation specifier. If not, the operands are serialized and pushed towards the root 264 of the tree. At the root 264 is a simplified processing element 262-L and accumulation buffer 266. The buffer 266 is indexed by the key and allows numerous operands to accumulate before being pushed back to the PEs 220 via the feedback network 290. Similar to MAUs 240, the reduction unit 260 is controlled by a translation table, indexed by the reduction key. Each table entry can reference a built in operation, like ADD, or a small atomic instruction block to provide a more sophisticated reduction operations and feedback policies. In a preferred implementation, for example, each table entry contains the operation, and four operands, the current accumulation, a reset value to reset the accumulation to upon feedback, the current number of tokens/end of emits received, and the amount of tokens received at which the value should be fed back, i.e. for an add,

acc[0] += input;
if (acc[2] == acc[3]) {
feedback acc[0];
acc[0] = acc[1];
acc[2] = 0;
}.

Sample feedback policies include return an operand to one or more PEs 220 for each operand received, or after every 10 operands, or after a special EndOfEmit token has been received from every PE 220. The variable feedback policies and the strict consistency and global coherence guaranteed by the root of the tree enable a number of synchronization primitives to be implemented in the reduction unit 260. A mutex, for example, uses the enforced serialization at the tree root 264, and the accumulation buffer 266 to provide atomic test and set, and conditional feedback to only return a token to the blocking feedback interface FIFO unit 232D of the associated requesting PE 220 when the mutex is available. The flyweight thread interaction provided by the reduction unit 260 enables algorithm driven synchronization. Variables and computation traditionally protected by locks can be replaced with true, tree-based arithmetic reductions, or globally serialized accumulations. In contrast to architectures that do not provide any consistency or coherence facilities, the reduction unit 260 makes reasoning about, and generating code much simpler. Compared to cache-based mechanisms, the reduction unit 260 offers reduced latency and increased efficiency by performing useful work during the synchronization process, and only providing coherence and consistency when explicitly needed. In general, the merge architecture according to the present invention seeks to provide discrete, dedicated hardware resources for well defined computational tasks. Computation, memory access and thread interaction are decoupled, and mapped to the modular, singly focused, PEs 220, MAUs 240, and reduction unit 260, respectively. Modules, like the cache which have been expanded beyond their traditional roles with great added complexity, are returned to their original roles, easing design and verification.

With respect to the overall system, in operation, each PE 220, with its associated memory access unit 240 (and associated cache bank) forms a decoupled execution lane, four of which are illustrated in FIG. 2. The lane is connected to a single port of the reduction unit 260, interconnected with other lanes in a bidirectional ring illustrated by the vertical signal path 292 and the destination of the feedback connection 290 from the root 264 of the reduction unit 260.

Since the blocking FIFO interface units described previously are a part of the architectural state, and FIFO interface operand recovery is difficult, PE units 220 are in-order, as described previously. The default state is non-operation. On program initiation, the control processor 210 will force the load of an instruction block by simulating a global jump instruction. Using the same virtual index mechanism as general loads, the PE 220 initiates a DMA memory fetch via the MAU 240 into its local instruction store of the memory 250. Execution will begin as soon as instructions are available. A global jump instruction or control processor command will load a new instruction block. The control processor 210 can affect program execution either by forcing an instruction load or by changing the instruction fetch translation table appropriately. The local instruction store functions as a circular buffer allowing currently executing blocks to overlap the fetch of subsequent instruction blocks.

The merge architectural framework specifies a set of translation tables for instruction blocks, memory access and reduction control, along with the minimum size of the accumulation buffer 266 in the reduction unit 260, the minimum internal buffer size in the MAU, and the minimum size blocking interface FIFO mailbox buffers. The finite size of these buffers imposes a strict set of constraints on any application using this architecture. However, some of these constraints can be minimized by separating the semantic usage of the resource from the implementation. As an example, consider a kernel that operates on the columns of a matrix, with an algorithmic dependency between the per-element computations in adjacent columns. If one column is allocated to each PC unit, the buffer space and the wrap around point is quickly exhausted, while waiting for the lead PC unit to complete its column and begin n+numPC column. In this usage scenario, the data operands in the ring network serve both as raw data and as tokens indicating it is legal to proceed with the dependent computation. When the available buffer space might be exceeded, the memory system can be used to buffer the raw data, while single (or sufficiently small number) of non-data tokens, indicating that the associated data is available in coherent state, can be transmitted through the ring network. In this approach, the system can efficiently provide the behavior of a large blocking FIFO buffer, without actually having such a structure or relying on expensive memory based coherence and consistency mechanisms. In the case of the reduction unit 260, the finite size of the accumulation buffer 266 (typically on the order of 64 entries limits the number of active keys, which thus limits the number of independent accumulations undertaken at one time. However, not all parts of the reduction operation need the consistency and coherence provided by the reduction unit 260 itself, and instead can be implemented with local coherence and consistency and a globally coherent and consistent meta operation. Much as in the above example, in which resources with weaker invariance guarantees were used in conjunction with meta-tokens passed through the hardware-based interaction mechanisms, local reduction or interaction mechanisms, such arithmetic units collocated with the cache banks (described in following paragraphs), can be used along with meta-tokens passed through the reduction unit to provide the same semantics offered by directly using the reduction unit, but with a larger number of accumulation buffer entries.

In another implementation, to supplement, a reduction unit (such as reduction unit 260) will include arithmetic units collocated with cache banks using an implementation based on Scatter-Add, which is described in “Scatter-Add in Parallel Architectures, 11th International Symposium on High Performance Computer Architecture, 2005 by Jung Ho Ahm and William J. Dally. These arithmetic units provide the same arithmetic operators as the tree-based unit 262-F first level, 262-M middle levels, and 262-L last level, but use the memory system as the accumulation buffer 266 and the MAU 240 as the access interface (as opposed to the dedicated emit FIFO and feedback FIFO interfaces). Using such units, large, variably sized, portions of the memory space can be treated as accumulation buffers (as opposed the small fixed number provided in the reduction unit). The tradeoff is weakened invariances and reduced performance and power efficiency.

Although the reduction unit is described above as a full tree, it only needs to provide the interface of such a structure. The reduction unit can implement a tree of any sparsity, including just a root node 264 and a interleaving network structure to route operands from the PEs 220. Regardless of the underlying implementation, a preferred feature of the reduction unit is low latency. The log or better depth of the tree ensures interaction latency remains low, even as the architecture scales to increasing numbers of PEs 220. In contrast, the memory access network 240, which plays a little or no role in synchronization, is optimized for high throughput to supply the necessary bandwidth to the PEs 220.

A cycle-realistic, execution-driven micro-architectural simulator has been developed using SystemC. Instruction execution in the PEs 220, reduction units 260 and MAUs 240, and other system features described above are all modeled in detail. DRAM timing simulation is based on DRAMsim.

The simulation system uses single issue, in-order PEs 220 with 32 general purpose registers per PE 220. Each cache bank is 8 kB, with one cache bank per PE, with a 4 bank minimum. The cache is 32-way set associative, with 32 byte lines. A MAU 240 can fetch up to 128 bits form the cache per access, with a two cycle latency. The cache is non-blocking and connects to off-chip DDR2-667 SDRAM. The local instruction store is 64 entries, the MAU local store is 128 words, the reduction tree accumulation buffer 266 has 64 entries and all interface FIFOs have 8 entries.

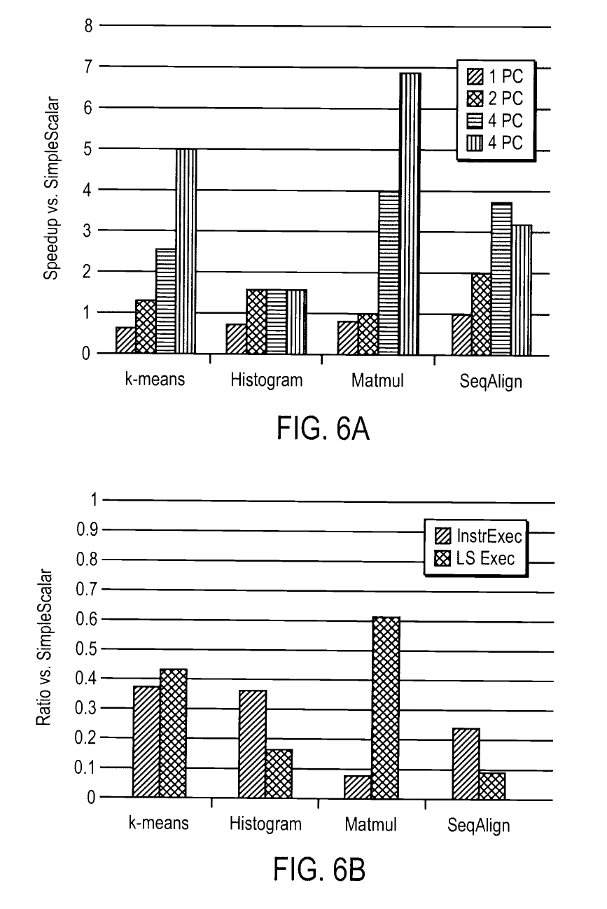

Four benchmarks are presented, dense matrix multiply for 192×192 floating point matrices, integer histogram for 32,768 uniformly distributed elements, k-means clustering for k=2, 1158×8 floating point data, and Smith-Waterman DNA sequence alignment scoring matrix generation for 512 base pairs. Performance relative to equivalent C-code (compiled with gcc-02) executed on the default configuration of SimpleScalar (4-wide 00) is shown in FIG. 6(a). Execution efficiency, in the form of the ratio of instructions executed and cache memory access relative to SimpleScalar is shown in FIG. 6(b).

Another advantage of the present invention is that software can be written in a simple programming format that does not require the user to understand the complexities of parallel processing, yet the program can be operated upon by the parallel computing architecture described herein. In such an implementation, there is a direct translation between the map and reduce call and the hardware. So for example, in an inner product, you collapse the multiplies and sums into some number of threads, which are then allocated to the PE 220's, the results at the completion of the thread execution are summed in the reduction unit 260, and used in subsequent computations. When the interaction/reduction cannot be directly performed in the tree of the reduction unit 260, the data to be combined is moved between PEs 220 via the ring network or the memory system 250 and tokens are passed through the ring and/or reduction unit 260 to provide necessary synchronization. In general, map and reduce calls are partitioned into threads by collapsing some of the potentially parallel map invocations into sequential threads, those threads executed on the PEs 220 and the results are combined using either the PEs 220 themselves or the reduction unit 260 as appropriate. In either case the reduction unit 260 is used to ensure the necessary synchronization is maintained.

Although the present invention is described with respect to certain preferred embodiments, modifications thereto will be apparent to those skilled in the art. For example, although the present invention describes the reduction units receiving both data signals as well as state signals based upon received keys, the reduction units can perform useful operations only state signals or on only data signals, for example. Accordingly, the present invention should be interpreted broadly, in the context of the specification above, and the claims below.

What is claimed is:

1. A method operating a parallel computing device comprising the steps of:
performing independent operations by a plurality of processing units arranged in a row to obtain a sequence of results from each of the processing units, the step of performing independent operations including accessing data from a common memory by each of the plurality of processing units; and
operating upon each of the results obtained from each of the processing units using a reduction unit to obtain a globally coherent and strictly consistent state signal, the globally coherent and strictly consistent state signal being fed back to each of the plurality of processing units in order to synchronize operations therebetween.

2. The method according to claim 1 wherein the step of operating uses a plurality of arithmetic units connected together in a tree.

3. The method according to claim 2 wherein the step of operating causes interaction of the results from each of the processing units.

4. The method according to claim 3 wherein the interaction of the results from each of the processing units is controlled using keys emitted from each of the processing units.

5. The method according to claim 1 wherein the step of accessing data accesses the data at a high bandwidth, and the step of operating upon the results operates at a low latency.

6. The method according to claim 1 wherein the steps of performing and operating use integer operations.

7. The method according to claim 1 wherein the steps of performing and operating use floating point operations.

8. The method according to claim 1 wherein the steps of performing and operating operate upon packed data and perform multi-precision operations.

9. The method according to claim 1 wherein the steps of performing and operating are globally controlled by a global controller.

10. The method according to claim 1 further including the step of translating a program into a parallel-computing program.

11. The method according to claim 10 wherein the step of translating includes a direct translation between a map and reduce call and the plurality of processing units and the reduction unit.

12. A parallel-computing device comprising:
a memory;
a plurality of at least four processor units that each operate dynamically and so that each processor unit in the plurality of processor units can bi-directionally communicate with the memory, each processor unit having an independent instruction set associated therewith so that execution of operations described by combinations of the instructions are performed independently,
wherein the independent operations include a first group of operations that operate upon data signals and produce arithmetic results, and a second group of operations that operate upon either state signals or data signals and produce logical results,
wherein each of the processor units in the row except the last processor unit can transfer either arithmetic results or logical results to a next processor unit in the row,
wherein each processor unit can transfer either arithmetic results or logical results to memory, and
wherein each processor can transfer either arithmetic results or logical results to a processor output;
an reduction unit, the reduction unit having inputs connected to each of the processor outputs, so that either the arithmetic results or the logical results can be input and operated upon by the dedicated reduction unit, wherein the reduction unit includes a nested plurality of interactive devices, wherein the interactive devices perform operations on either arithmetic results or logical results from some or all of the processor units to respectively obtain reduced arithmetic results or reduced logical results,
wherein the reduction unit includes a feedback path so that either the reduced arithmetic results or reduced logical results can be transferred the plurality of processor units as data signals or state signals, respectively, and
wherein the dedicated reduction unit provides low bandwidth, low latency operations that provide for scheduling of high bandwidth, high latency operations between the memory and each of the processor units.

13. The apparatus according to claim 12 wherein a width of the signals that provide the arithmetic and the logical results is at least 32 bit integer, single precision floating point.

14. The apparatus according to claim 12 wherein a width of the signals that provide the arithmetic and the logical results is one of at least 64 bit integer, single precision floating point, 64 bit integer, double precision floating point, and 64 bit integer, reduced precision floating point.

15. The apparatus according to claim 12 wherein the output of the reduction unit generates a globally coherent signal that is used for synchronization in order to provide for scheduling.

16. The apparatus according to claim 15 wherein the reduction unit uses a key obtained from each of the processing units in order for the synchronization.

17. The apparatus according to claim 12 wherein the reduction unit performs negative operations.

18. The apparatus according to claim 12 wherein the processing units operate in an integer mode.

19. The apparatus according to claim 12 wherein the processing units operate in a floating point mode.

20. The apparatus according to claim 12 wherein the plurality of at least four processing units are arranged in a row.
